(19) United States
(12) Patent Application Publication
(10) Pub. No.: US 2025/0267504 A1
(43) Pub. Date: Aug. 21, 2025

(54) DEVICE AND METHOD FOR REPORTING QUEUE SIZE OF ACCESS CATEGORY

(71) Applicant: Realtek Semiconductor Corp., HsinChu (TW)

(72) Inventors: Han-Xiang Liu, HsinChu (TW); Chun-Chu Chang, HsinChu (TW)

(73) Assignee: Realtek Semiconductor Corp., HsinChu (TW)

(21) Appl. No.: 18/950,228

(22) Filed: Nov. 18, 2024

(30) Foreign Application Priority Data
Feb. 19, 2024 (TW) 113105764

(51) Int. Cl. H04W 28/02; H04W 84/12

(52) U.S. Cl. CPC H04W 28/0268; H04W 28/0278; H04W 84/12

(57) ABSTRACT

A communication device for reporting queue size (QS) of access category (AC) includes: a determination circuit, for determining a number of at least one media access control (MAC) protocol data unit (MPDU) according to a length parameter; a comparing circuit, for comparing the number of the at least one MPDU, a first threshold and a second threshold, to generate a comparison result, wherein the first threshold is greater than the second threshold; a processing circuit, for generating the at least one MPDU, and filling a plurality of QSs of a plurality of traffic identifiers (TIDs) associated with a plurality of ACs into the at least one MPDU according to the comparison result; an aggregation circuit, for aggregating the at least one MPDU, to generate an aggregated MPDU (A-MPDU); and a transmitting circuit, for transmitting the A-MPDU to a network device.

### BACKGROUND OF THE INVENTION

### 1. Field of the Invention

The present invention relates to a device and a method used in a wireless communication system, and more particularly, to a device and a method of reporting queue size (QS) of access category (AC).

### 2. Description of the Prior Art

In wireless local area networks (WLANs), traffic (e.g. access category (AC) or traffic identifier (TID)) is classified. ACs/TIDS with high priority may be transmitted first to achieve low latency. By transmitting a trigger frame from a network device to a communication device, ACs/TIDs and a maximum number of packets transmitted by the communication device are configured. Before the network device transmits the trigger frame to the communication device, however, the communication device needs to actively or passively report queue sizes (QSs) of the ACs/TIDs to the network device. Thus, how to effectively report QSs of the ACs/TIDs is an important problem to be solved.

### SUMMARY OF THE INVENTION

The present invention provides a device and a method to solve the abovementioned problem.

A communication device for reporting queue size (QS) of access category (AC) comprises: a determination circuit, for determining a number of at least one media access control (MAC) protocol data unit (MPDU) according to a length parameter; a comparing circuit, coupled to the determination circuit, for comparing the number of the at least one MPDU, a first threshold and a second threshold, to generate a comparison result, wherein the first threshold is greater than the second threshold; a processing circuit, coupled to the comparing circuit, for generating the at least one MPDU, and filling a plurality of QSs of a plurality of traffic identifiers (TIDs) associated with a plurality of ACs into the at least one MPDU according to the comparison result; an aggregation circuit, coupled to the processing circuit, for aggregating the at least one MPDU, to generate an aggregated MPDU (A-MPDU); and a transmitting circuit, coupled to the aggregation circuit, for transmitting the A-MPDU to a network device.

A method for reporting queue size (QS) of access category (AC) comprises: determining a number of at least one media access control (MAC) protocol data unit (MPDU) according to a length parameter; comparing the number of the at least one MPDU, a first threshold and a second threshold, to generate a comparison result, wherein the first threshold is greater than the second threshold; generating the at least one MPDU, and filling a plurality of QSs of a plurality of traffic identifiers (TIDs) associated with a plurality of ACs into the at least one MPDU according to the comparison result; aggregating the at least one MPDU, to generate an aggregated MPDU (A-MPDU); and transmitting the A-MPDU to a network device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a communication system according to an example of the present invention.

FIG. 2 is a schematic diagram of a communication device according to an example of the present invention.

FIG. 3 is a flowchart of a process according to an example of the present invention.

FIG. 4 is a flowchart of an A-MPDU according to an example of the present invention.

FIG. 5 is a flowchart of a process according to an example of the present invention.

FIG. 6 is a flowchart of an A-MPDU according to an example of the present invention.

FIG. 7 is a flowchart of a process according to an example of the present invention.

FIG. 8 is a flowchart of an A-MPDU according to an example of the present invention.

FIG. 9 is a flowchart of a process according to an example of the present invention.

### DETAILED DESCRIPTION

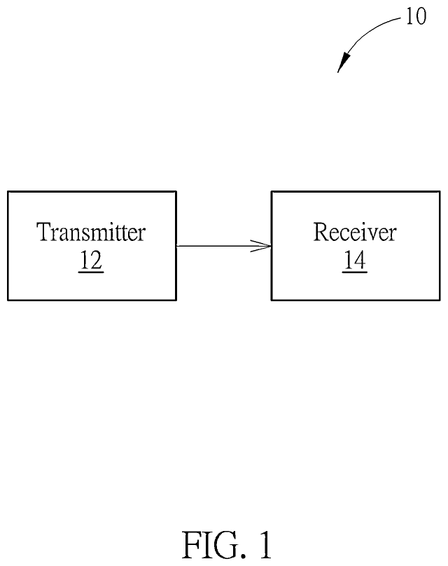

FIG. 1 is a schematic diagram of a communication system 10 according to an example of the present invention. The communication system 10 may be any communication system using an orthogonal frequency-division multiplexing (OFDM) technique (also termed as a discrete multi-tone modulation (DMT) technique), and is composed of a transmitter 12 and a receiver 14. The communication system 10 may be any wired communication system such as an asymmetric digital subscriber line (ADSL) system, a power line communication (PLC) system or an Ethernet over coax (EOC), but is not limited herein. The communication system 10 may alternatively be any wireless communication system such as a wireless local area network (WLAN), a Digital Video Broadcasting (DVB) system, a Long Term Evolution (LTE) system, a Long Term Evolution-advanced (LTE-A) system or a fifth generation (5G) system, but is not limited herein. In addition, the transmitter 12 and the receiver 14 may be installed in a mobile phone, a laptop, a personal computer, an access point (AP), a base station, etc., but not limited herein.

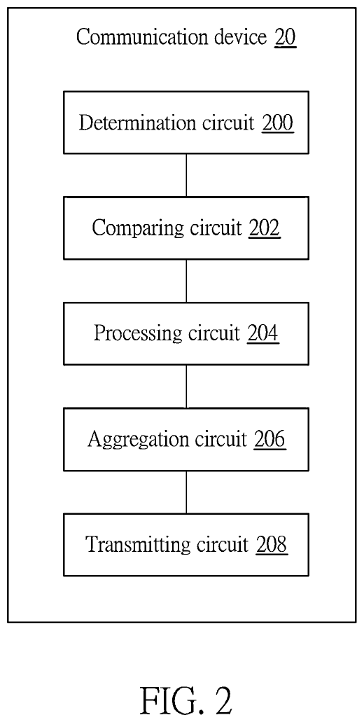

FIG. 2 is a schematic diagram of a communication device 20 according to an example of the present invention. The communication device 20 may be applied to the transmitter 12 or the receiver 14 of FIG. 1 to report queue size (QS) of access category (AC). The communication device 20 comprises a determination circuit 200, a comparing circuit 202, a processing circuit 204, an aggregation circuit 206 and a transmitting circuit 208. In detail, the determination circuit 200 is configured to determine a number of at least one media access control (MAC) protocol data unit (MPDU) according to a length parameter. The comparing circuit 202 is coupled to the determination circuit 200, and is configured to compare the number of the at least one MPDU, a first threshold and a second threshold, to generate a comparison result, wherein the first threshold is greater than the second threshold. The processing circuit 204 is coupled to the comparing circuit 202, and is configured to generate the at least one MPDU and fill a plurality of QSs of a plurality of traffic identifiers (TIDs) associated with a plurality of ACs into the at least one MPDU according to the comparison result. The aggregation circuit 206 is coupled to the processing circuit 204, and is configured to aggregate the at least one MPDU to generate an aggregated MPDU (A-MPDU). The transmitting circuit 208 is coupled to the aggregation circuit 206, and is configured to transmit the A-MPDU to a network device. The network device may be applied to the receiver 14 or the transmitter 12 of FIG. 1.

In one example, the at least one MPDU comprises at least one first control field, at least one second control field and at least one third control field. In one example, each of the at least one first control field (i.e., each first control field) comprises a quality of service (QOS) data frame or a QoS null frame. In one example, each of the at least one second control field (i.e., each second control field) comprises an access control information (ACI) high subfield and a QS high subfield. In one example, each of the at least one third control field (i.e., each third control field) comprises an ACI bitmap subfield, a delta TID subfield and a QS all subfield. In one example, if/when the at least one second control field comprises more than one second control field, then each of the at least one second control field comprises the same information. In one example, if/when the at least one third control field comprises more than one third control field, then each of the at least one third control field comprises the same information.

In one example, the QoS data frame or the Qos null frame comprises a TID and a QS of the TID. In one example, the ACI high subfield comprises a first index indicating an AC, and the QS high subfield comprises a sum of QSs of all TIDs indicated by the first index. In one example, the ACI bitmap subfield comprises a second index indicating at least one AC, the delta TID subfield is used for indicating a number of TIDs, and the QS all subfield comprises a sum of QSs of all TIDs indicated by the second index. In one example, the QoS data frame or the Qos null frame is comprised in a QoS control field. In one example, the ACI high subfield, the QS high subfield, the ACI bitmap subfield, the delta TID subfield and the QS all subfield are in a high throughput (HT) control field. In one example, the QoS control field and the HT control field are in a MAC header.

In one example, the step of the processing circuit 204 filling the plurality of QSs of the plurality of TIDs associated with the plurality of ACs into the at least one MPDU according to the comparison result comprises: when the number of the at least one MPDU is not smaller than the first threshold, the processing circuit 204 fills the plurality of QSs into the at least one first control field in order according to the plurality of TIDS (e.g. a plurality of values of the plurality of TIDs). For example, the processing circuit 204 fills a QS of a TID with a smallest value into the 1^{st} first control field and fills a QS of a TID with a second smallest value into the 2^{nd} first control field, and so on. Then, if/when at least one remaining first control field among the at least one first control field is not filled (i.e. the at least one remaining first control field does not comprises the QS(s)), the processing circuit 204 changes at least one remaining MPDU comprising the at least one remaining first control field to at least one end-of-frame (EOF) padding subframe. In one example, an actual number of the at least one MPDU is the first threshold, and a number of the at least one EOF padding subframe is a difference between the number of the at least one MPDU determined by the determination circuit 200 and the first threshold. In one example, a MPDU length of each of the at least one EOF padding subframe (i.e., each EOF padding subframe) is 0. In one example, the processing circuit 204 fills the plurality of TIDS into the at least one MPDU. The details of filling the plurality of TIDs into the at least one MPDU can be known by referring to the previous example for the step of the processing circuit 204 filling the plurality of QSs into the at least one MPDU, and are not narrated herein for brevity.

In one example, the step of the processing circuit 204 filling the plurality of QSs of the plurality of TIDs associated with the plurality of ACs into the at least one MPDU according to the comparison result comprises: when the number of the at least one MPDU is smaller than the first threshold and is not smaller than the second threshold, the processing circuit 204 fills at least one QS of at least one TID among the plurality of TIDs into the at least one first control field in order according to a priority order of the plurality of ACs. For example, when at least one remaining first control field among the at least one first control field is not filled, the processing circuit 204 fills a QS of a TID with a highest priority into the 1^{st} first control field and fills a QS of a TID with a second highest priority into the 2^{nd} first control field, and so on. Then, the processing circuit 204 fills at least one paired QS of at least one paired TID with high priority among the plurality of TIDs into the at least one remaining first control field in order according to the priority order and fills a remaining paired QS of a remaining paired TID with a highest priority among at least one remaining paired TID other than the at least one paired TID in the plurality of TIDS into the at least one second control field (e.g. fills a sum of the remaining paired QS and a QS with the same AC into each of the at least one second control field),. When the at least one first control field is filled, the processing circuit 204 fills a paired QS of a paired TID with a highest priority among the at least one paired TID into the at least one second control field (e.g. fills a sum of the paired QS and a QS with the same AC into each of the at least one second control field). The processing circuit 204 fills a QS of a TID with a second highest priority among the at least one remaining paired TID or the at least one paired TID into the at least one third control field (e.g. fills the QS into each of the at least one third control field), or fills at least one remaining QS of at least one remaining TID among the at least one remaining paired TID or the at least one paired TID into the at least one third control field (e.g. fills a sum of the at least one remaining QS into each of the at least one third control field). In one example, the processing circuit 204 fills the plurality of TIDs (or the plurality of ACs) into the at least one MPDU. The details of filling the plurality of TIDs (or the plurality of ACs) into the at least one MPDU can be known by referring to the previous example for the step of the processing circuit 204 filling the plurality of QSs into the at least one MPDU, and are not narrated herein for brevity.

In one example, the step of the processing circuit 204 filling the plurality of QSs of the plurality of TIDs associated with the plurality of ACs into the at least one MPDU according to the comparison result comprises: when the number of the at least one MPDU is smaller than the second threshold, the processing circuit 204 fills a QS of a TID with a highest priority among the at least one TID and a paired QS of a paired TID corresponding to the TID into the at least one second control field according to a priority order of the plurality of ACs. For example, the processing circuit 204 fills a sum of the QS and the paired QS into each of the at least one second control field. The QS and the paired QS have (or correspond to) the same AC. Then, the processing circuit 204 fills at least one QS of at least one TID other than the TID and the paired TID in the plurality of TIDs into the at least one first control field in order according to the priority order. For example, the processing circuit 204 fills a QS of a TID with a highest priority among the at least one TID into the 1^{st} first control field and fills a QS of a TID with a second highest priority among the at least one TID into the 2^{nd} first control field, and so on. The processing circuit 204 fills a remaining QS of a remaining TID with a highest priority among at least one remaining TID in the plurality of TIDs into the at least one third control field (e.g. fills the remaining QS into each of the at least one third control field), or fills at least one remaining QS of the at least one remaining TID into the at least one third control field (e.g. fills a sum of the at least one remaining QS into each of the at least one third control field). In one example, the processing circuit 204 fills the plurality of TIDs (or the plurality of ACs) into the at least one MPDU. The details of filling the plurality of TIDs (or the plurality of ACs) into the at least one MPDU can be known by referring to the previous example for the step of the processing circuit 204 filling the plurality of QSs into the at least one MPDU, and are not narrated herein for brevity.

In one example, (when the number of the at least one MPDU is insufficient, for example, when the number of the at least one MPDU is smaller than the first threshold,) if/when any of the plurality of QSs has a value of 0, the processing circuit 204 ignores the QS with the value of 0 (i.e. does not fill the QS with the value of 0 into the at least one MPDU). That is, in the case of insufficient resources, the communication device 20 does not report the QS with the value of 0. In one example, the processing circuit 204 fills a corresponding QS instead of the ignored QS into the at least one MPDU. The corresponding QS and the ignored QS are associated with the same AC. In one example, after the processing circuit 204 fills the plurality of QSs of the plurality of TIDs associated with the plurality of ACs into the at least one MPDU, the processing circuit 204 ignores the QS(s) that is not filled if/when any QS of the plurality of QSs is not filled into the at least one MPDU. That is, in the case of insufficient resources, the communication device 20 reports the QS(s) of the TID(s) with higher priority (i.e. does not report the QSs of all TIDs).

In one example, an AC priority table comprises the priority order of the plurality of ACs. In one example, the AC priority table is updated (e.g. by the communication device 20) periodically or aperiodically. For example, the communication device 20 updates the AC priority table when an event occurs (e.g. a number of times that the communication device 20 transmits the A-MPDU achieves a third threshold). In the AC priority table, the updated preferred TID is the paired TID of the original preferred TID. The third threshold is determined by a user. In one example, the AC priority table is determined by a user (e.g. according to usage scenarios of the communication device 20). The usage scenarios comprise games, video conferencing, video calls, smart devices and/or national alarms, but are not limited herein. In one example, the priority order is determined by a user (e.g. according to the usage scenarios of the communication device 20). The usage scenarios comprise games, video conferencing, video calls, smart devices and/or national alarms, but are not limited herein. In one example, the priority order is determined according to the plurality of values of the plurality of QSs (e.g. in specific scenarios). The specific scenarios comprise downloading data, watching high-definition videos and/or making Internet calls, but are not limited herein. For example, the greater value of the QS, the higher priority of the TID.

In one example, the length parameter is an A-MPDU maximum length. The A-MPDU maximum length is a maximum number of MPDUs that the aggregation circuit 206 is able to aggregate. In one example, the communication device 20 further comprises a receiving circuit (not shown in FIG. 2) coupled to the determination circuit 200 and configured to receive the length parameter (e.g. in a buffer status report poll (BSRP)) from the network device, wherein the length parameter is a BSRP uplink (UL) length. In one example, in an unsolicited mode, the communication device 20 actively reports the plurality of QSs of the plurality of TIDs to the network device according to the A-MPDU maximum length. In one example, in a solicited mode, the communication device 20 reports the plurality of QSs of the plurality of TIDs to the network device according to the BSRP UL length, in response to the BSRP UL length from the network device.

In one example, the first threshold is a maximum number of the plurality of TIDs. In one example, the second threshold is a number of the plurality of ACs. In one example, the plurality of ACs comprises best effort (BE), background (BG), video (VI) and voice (VO), but are not limited herein. In one example, one of the plurality of ACs corresponds to one or more (e.g. 2) of the plurality of TIDS, and one of the plurality of TIDs corresponds to one of the plurality of ACs. In one example, the plurality of TIDs corresponds to the plurality of QSs, respectively. In one example, the plurality of TIDS are independent of each other. In one example, two of the plurality of TIDs are paired TIDs of each other, if/when the two TIDs correspond to the same AC.

In one example, the network device transmits a trigger frame to the communication device 20, after receiving the A-MPDU. The trigger frame may comprise an AC and a UL length (e.g. a basic trigger UL length). The AC is used for indicating a type of data transmitted by the communication device 20 to the network device, and the UL length is a maximum length of the data (e.g. a maximum number of packets) transmitted by the communication device 20 to the network device. In one example, the communication device 20 transits the data to the network device according to the trigger frame.

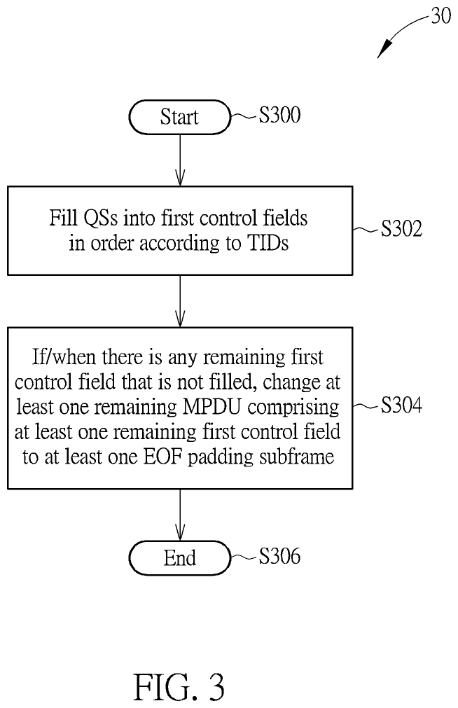

FIG. 3 is a flowchart of a process 30 according to an example of the present invention. When the number of the MPDUs is not smaller than the first threshold, the communication device 20 may fill the QSs of the TIDs into the MPDUs according to the process 30. The process 30 includes the following steps:

Step S300: Start.

Step S302: Fill QSs into first control fields in order according to TIDs.

Step S304: If/when there is any remaining first control field that is not filled, change at least one remaining MPDU comprising at least one remaining first control field to at least one EOF padding subframe.

Step S306: End.

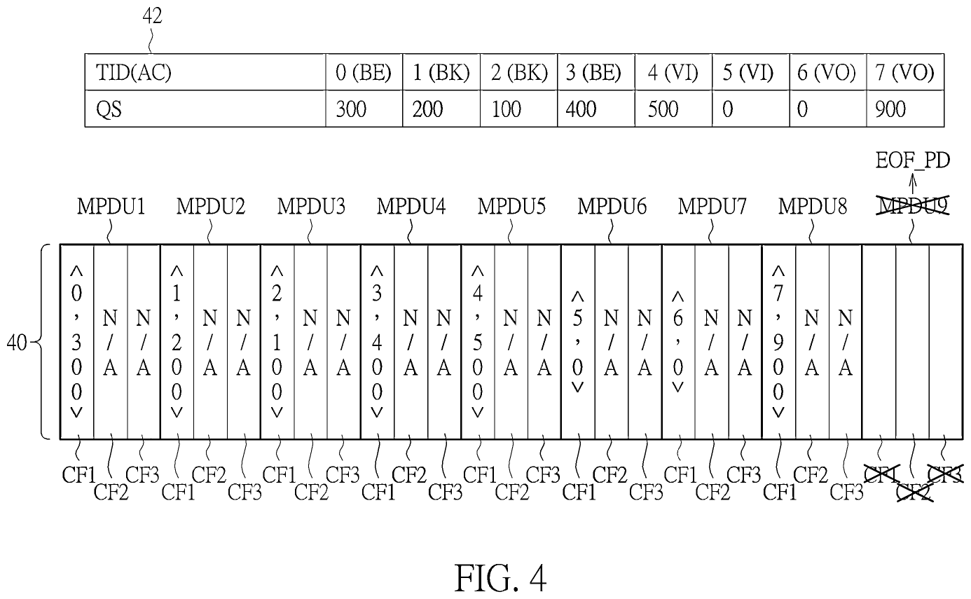

FIG. 4 is a flowchart of an A-MPDU 40 according to an example of the present invention. Assuming that the number of MPDUs is 9 and the first threshold is 8, FIG. 4 may be applied to the process 30. The A-MPDU 40 comprises 9 MPDUS MPDU1-MPDU9, and each of the MPDUS MPDU1-MPDU9 comprises control fields CF1-CF3. A table 42 comprises 8 TIDs 0-7, ACs of the TIDs 0-7 and QSs of the TIDs 0-7. The communication device 20 fills the TIDs 0-7 and the QSs of the TIDS 0-7 into the control fields CF1 of the MPDUS MPDU1-MPDU8 in order. For example, the TID 0 with a smallest value and the QS 300 are filled into the control field CF1 of the MPDU MPDU1, and the TID 1 with a second smallest value and the QS 400 are filled into the control field CF1 of the MPDU MPDU2, and so on. Since all QSs have been filled, the communication device 20 changes the MPDU MPDU9 to an EOF padding subframe EOF PD, and fills a padding value (represented by N/A) into the remaining control fields (e.g. the control fields CF2-CF3 of the MPDUS MPDU1-MPDU8). It should be noted that a MPDU length of the EOF padding subframe EOF PD is 0, and the EOF padding subframe EOF PD does not comprises the control fields CF1-CF3.

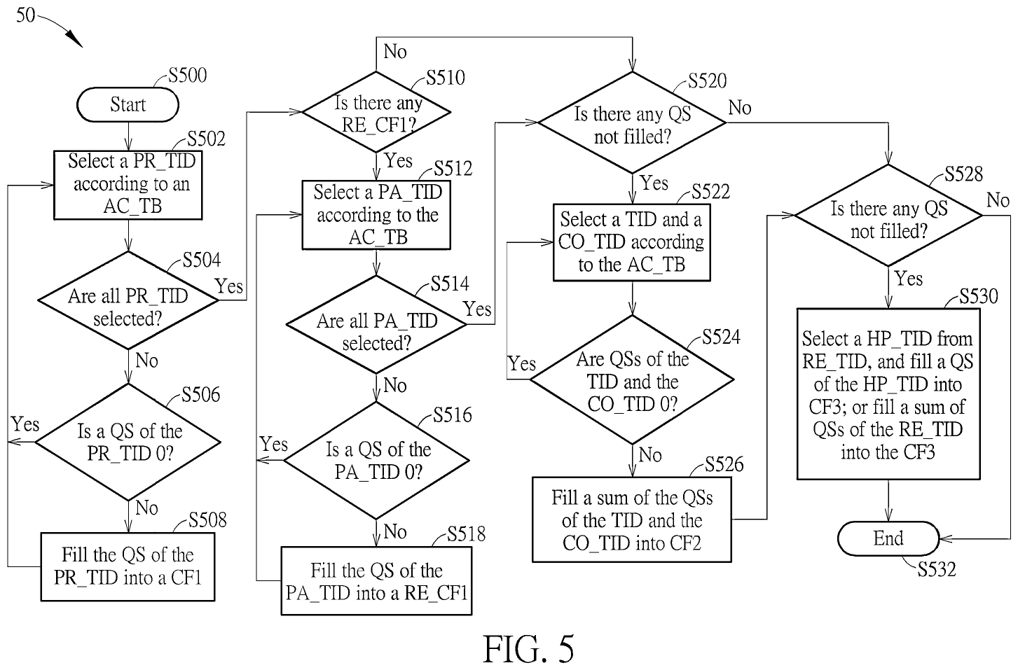

FIG. 5 is a flowchart of a process 50 according to an example of the present invention. When the number of the MPDUs is smaller than the first threshold and is not smaller than the second threshold, the communication device 20 may fill the QSs of the TIDs into the MPDUs according to the process 50. The process 50 includes the following steps:

Step S500: Start.

Step S502: Select a preferred TID PR_TID according to an AC priority table AC_TB.

Step S504: Are all preferred TIDs PR_TID selected? If yes, perform Step S510. If no, perform Step S506.

Step S506: Is a QS of the preferred TID PR_TID 0? If yes, perform Step S502. If no, perform Step S508.

Step S508: Fill the QS of the preferred TID PR_TID into a first control filed CF1.

Step S510: Is there any remaining first control field RE_CF1? If yes, perform Step S512. If no, perform Step S520.

Step S512: Select a paired TID PA_TID according to the AC priority table AC_TB.

Step S514: Are all paired TIDS PA_TID selected? If yes, perform Step S520. If no, perform Step S516.

Step S516: Is a QS of the paired TID PA_TID 0? If yes, perform Step S512. If no, perform Step S518.

Step S518: Fill the QS of the paired TID PA_TID into a remaining first control field RE_CF1, and performs Step S512.

Step S520: Is there any QS not filled? If yes, perform Step S522. If no, perform Step S528.

Step S522: Select a TID TID and a corresponding paired TID CO_TID according to the AC priority table AC_TB, wherein the TID TID and the corresponding paired TID CO_TID have the same AC.

Step S524: Are QSs of the TID TID and the corresponding paired TID CO_TID 0? If yes, perform Step S522. If no, perform Step S526.

Step S526: Fill a sum of the QSs of the TID TID and the corresponding paired TID CO_TID into second control fields CF2.

Step S528: Is there any QS not filled? If yes, perform Step S530. If no, perform Step S532.

Step S530: Select a TID HP_TID with a highest priority from remaining TIDS RE_TID, and fill a QS of the TID HP_TID with the highest priority into third control fields CF3; or fill a sum of QSs of the remaining TIDS RE_TID into the third control fields CF3.

Step S532: End.

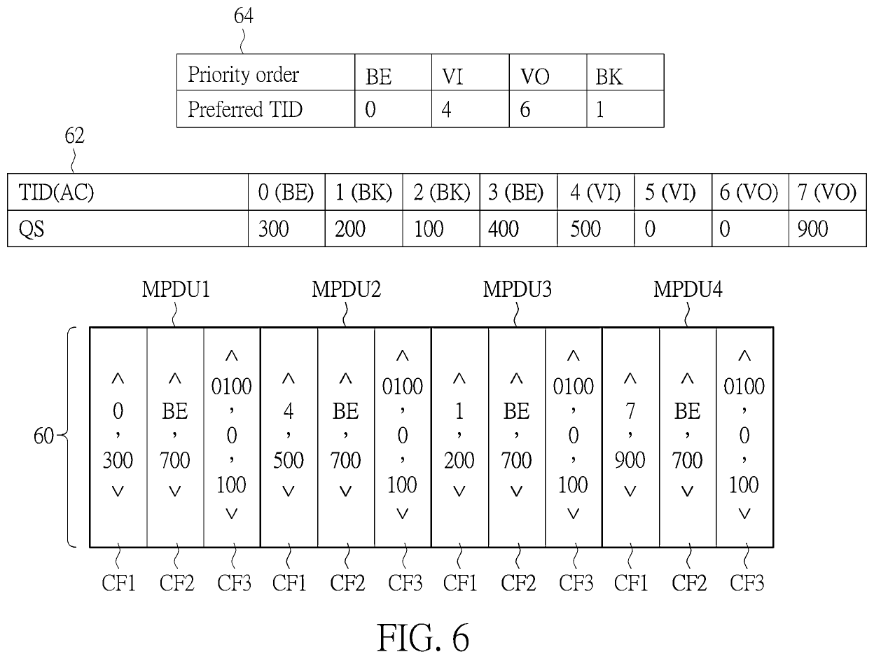

FIG. 6 is a flowchart of an A-MPDU 60 according to an example of the present invention. Assuming that the number of MPDUs is 4, the first threshold is 8 and the second threshold is 4, FIG. 6 may be applied to the process 50. The A-MPDU 60 comprises 4 MPDUS MPDU1-MPDU4, and each of the MPDUS MPDU1-MPDU4 comprises control fields CF1-CF3. A table 62 comprises 8 TIDs 0-7, ACs of the TIDS 0-7 and QSs of the TIDs 0-7. An AC priority table 64 comprises a priority order of the ACs and preferred TIDs. The priority order of the ACs is BE, VI, VO and BK, and the preferred TIDs are the TIDs 0, 4, 6 and 1. The communication device 20 fills the TIDs 0, 4 and 1 and the QSs 300, 200 and 500 into the control fields CF1 of the MPDUS MPUD1-MPDU3 in order according to the AC priority table 64. Since the QS of the TID 6 is 0, the communication device ignores the TID 6 and the QS 0. Then, since the TID 6 with the AC VO is ignored, the communication device 20 fills the TID 7 with the same AC VO and the QS 900 into the control field CF1 of the MPDU MPDU4. Since the AC BE has the highest priority, the communication device 20 fills the AC BE and a sum 700 (300+400) of the QSs of the TIDs 0 and 3 with the AC BE into the control fields CF2 of the MPDUs MPUDI-MPDU4. The QSs of the TIDs 2 and 5 are not filled. Since the QS of the TID 5 is 0, the communication device 20 ignores the TID 5 and the QS 0. Thus, the communication device 20 fills the AC BK (represented by 0100) of the TID 2, a number of the TIDs (represented by 0) and the QS 100 of the TID 2 into the control fields CF3 of the MPDUS MPUD1-MPDU4.

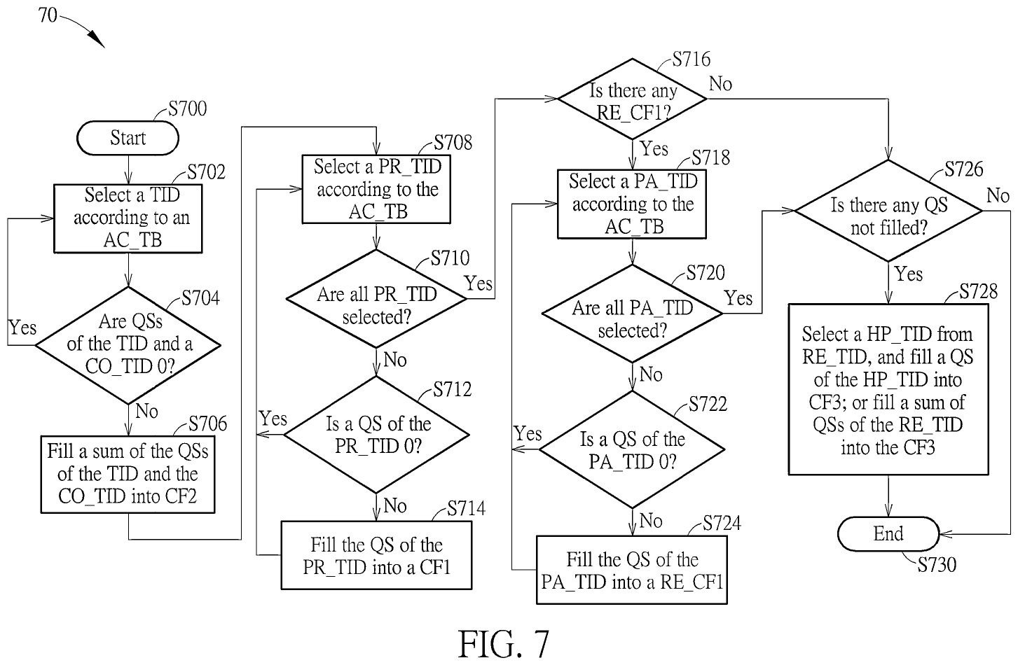

FIG. 7 is a flowchart of a process 70 according to an example of the present invention. When the number of the MPDUs is smaller than the second threshold, the communication device 20 may fill the QSs of the TIDs into the MPDUs according to the process 70. The process 70 includes the following steps:

Step S700: Start.

Step S702: Select a TID TID according to an AC priority table AC_TB.

Step S704: Are QSs of the TID TID and a corresponding paired TID CO_TID 0? If yes, perform Step S702. If no, perform Step S706.

Step S706: Fill a sum of the QSs of the TID TID and the corresponding paired TID CO_TID into second control fields CF2.

Step S708: Select a preferred TID PR_TID according to the AC priority table AC_TB.

Step S710: Are all preferred TIDS PR_TID selected? If yes, perform Step S716. If no, perform Step S712.

Step S712: Is a QS of the preferred TID PR_TID 0? If yes, perform Step S708. If no, perform Step S714.

Step S714: Fill the QS of the preferred TID PR_TID into a first control field CF1, and perform Step S708.

Step S716: Is there any remaining first control field RE_CF1? If yes, perform Step S718. If no, perform Step S726.

Step S718: Select a paired TID PA_TID according to the AC priority table AC_TB.

Step S720: Are all paired TIDS PA_TID selected? If yes, perform Step S726. If no, perform Step S722.

Step S722: Is a QS of the paired TID PA_TID 0? If yes, perform Step S718. If no, perform Step S724.

Step S724: Fill the QS of the paired TID PA_TID into a remaining first control field RE_CF1, and perform Step S718.

Step S726: Is there any QS not filled? If yes, perform Step S728. If no, perform Step S730.

Step S728: Select a TID HP_TID with a highest priority from remaining TIDS RE_TID, and fill a QS of the TID HP_TID with the highest priority into third control fields CF3; or fill a sum of QSs of the remaining TIDS RE_TID into the third control fields CF3.

Step S730: End.

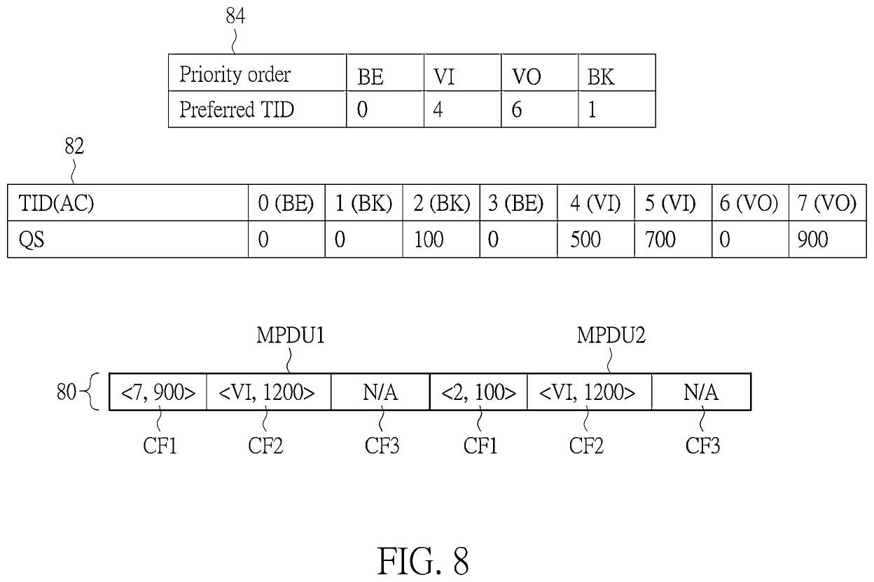

FIG. 8 is a flowchart of an A-MPDU 80 according to an example of the present invention. Assuming that the number of MPDUs is 2, the first threshold is 8 and the second threshold is 4, FIG. 8 may be applied to the process 70. The A-MPDU 80 comprises 2 MPDUS MPDU1-MPDU2, and each of the MPDUS MPDU1-MPDU2 comprises control fields CF1-CF3. A table 82 comprises 8 TIDs 0-7, ACs of the TIDs 0-7 and QSs of the TIDs 0-7. An AC priority table 84 comprises a priority order of the ACs and preferred TIDs. The priority order of the ACs is BE, VI, VO and BK, and the preferred TIDs are the TIDs 0, 4, 6 and 1. The AC with the highest priority is BE. The QSs of the TIDS 0 and 3 with the AC BE is 0, however, so the communication device 20 ignores the TIDs 0 and 3 and the QSs 0. The AC with the second highest priority is VI. The communication device 20 fills a sum 1200 (500+700) of the QSs of the TIDs 4 and 5 with the AC VI into the control fields CF2 of the MPDUs MPDU1-MPDU2. The AC with the third highest priority is VO. The QS of the preferred TID 6 with the AC VO is 0, however, so the communication device 20 ignores the TID 6 and the QS 0 and fills the TID 7 with the AC VO and the QS 900 into the control field CF1 of the MPDU MPDU1. The AC with the lowest priority is BK. The QS of the preferred TID 1 with the AC BK is 0, however, so the communication device 20 ignores the TID 1 and the QS 0 and fills the TID 2 with the AC BK and the QS 100 into the control field CF1 of the MPDU MPDU2. Since all QSs have been filled, the communication device 20 fills a padding value (represented by N/A) into the remaining control fields (e.g. the control fields CF3 of the MPDUs MPDU1-MPDU2).

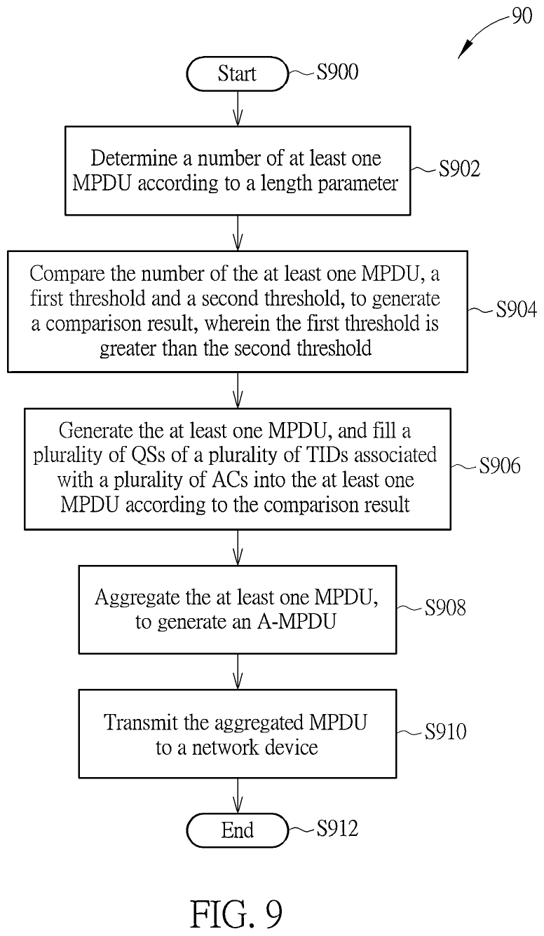

Operations of the communication device 20 in the above examples can be summarized into a process 90 shown in FIG. 9, which includes the following steps:

Step S900: Start.

Step S902: Determine a number of at least one MPDU according to a length parameter.

Step S904: Compare the number of the at least one MPDU, a first threshold and a second threshold, to generate a comparison result, wherein the first threshold is greater than the second threshold.

Step S906: Generate the at least one MPDU, and fill a plurality of QSs of a plurality of TIDs associated with a plurality of ACs into the at least one MPDU according to the comparison result.

Step S908: Aggregate the at least one MPDU, to generate an A-MPDU.

Step S910: Transmit the aggregated MPDU to a network device.

Step S912: End.

A detailed description and variations of the process 90 can be known by referring to the above description, and are not narrated herein.

The terms “first” and “second” described above distinguish the related description, but do not limit the order of the related description. The term “according to” described above may be replaced by the term “via”, “by using” or “in response to”. The term “comprise” described above may be replaced by the term “is”. The terms “when” and “if” described above may be replaced by the term “in response to”.

It should be noted that there are various possible realizations of the communication device 20 (including the determination circuit 200, the comparing circuit 202, the processing circuit 204, the aggregation circuit 206 and the transmitting circuit 208). For example, the circuits mentioned above may be integrated into one or more circuits. In addition, the communication device 20 and the circuits in the communication device 20 may be realized by hardware (e.g. circuits), software, firmware (known as a combination of a hardware device, computer instructions and data that reside as read-only software on the hardware device), an electronic system or a combination of the devices mentioned above, but are not limited herein.

To sum up, the present invention provides a device and a method for reporting QS of AC. The A-MPDU comprises QSs of multiple ACs/TIDs. The communication device may transmit the QSs of the multiple ACs/TIDs at once by transmitting the A-MPDU. Thus, the problem of how to effectively report the QSs of the ACs/TIDs can be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device for reporting queue size (QS) of access category (AC), comprising:
a determination circuit, for determining a number of at least one media access control (MAC) protocol data unit (MPDU) according to a length parameter;
a comparing circuit, coupled to the determination circuit, for comparing the number of the at least one MPDU, a first threshold and a second threshold, to generate a comparison result, wherein the first threshold is greater than the second threshold;
a processing circuit, coupled to the comparing circuit, for generating the at least one MPDU, and filling a plurality of QSs of a plurality of traffic identifiers (TIDs) associated with a plurality of ACs into the at least one MPDU according to the comparison result;
an aggregation circuit, coupled to the processing circuit, for aggregating the at least one MPDU, to generate an aggregated MPDU (A-MPDU); and
a transmitting circuit, coupled to the aggregation circuit, for transmitting the A-MPDU to a network device.

2. The communication device of claim 1, wherein the at least one MPDU comprises at least one first control field, at least one second control field and at least one third control field.

3. The communication device of claim 1, wherein the step of filling the plurality of QSs of the plurality of TIDs associated with the plurality of ACs into the at least one MPDU according to the comparison result comprises:
when the number of the at least one MPDU is not smaller than the first threshold, filling the plurality of QSs into the at least one first control field in order according to the plurality of TIDS,; and
when at least one remaining first control field among the at least one first control field is not filled, changing at least one remaining MPDU comprising the at least one remaining first control field to at least one end-of-frame (EOF) padding subframe.

4. The communication device of claim 1, wherein the step of filling the plurality of QSs of the plurality of TIDs associated with the plurality of ACs into the at least one MPDU according to the comparison result comprises:
when the number of the at least one MPDU is smaller than the first threshold and is not smaller than the second threshold, filling at least one QS of at least one TID among the plurality of TIDs into the at least one first control field in order according to a priority order of the plurality of ACs;
when at least one remaining first control field among the at least one first control field is not filled, filling at least one paired QS of at least one paired TID with high priority among the plurality of TIDs into the at least one remaining first control field in order according to the priority order and filling a remaining paired QS of a remaining paired TID with a highest priority among at least one remaining paired TID other than the at least one paired TID in the plurality of TIDS into the at least one second control field,;
when the at least one first control field is filled, filling a paired QS of a paired TID with a highest priority among the at least one paired TID into the at least one second control field; and
filling a QS of a TID with a second highest priority among the at least one remaining paired TID or the at least one paired TID into the at least one third control field, or filling at least one remaining QS of at least one remaining TID among the at least one remaining paired TID or the at least one paired TID into the at least one third control field;
wherein when any of the plurality of QSs has a value of 0, the processing circuit ignores the QS with the value of 0.

5. The communication device of claim 1, wherein the step of filling the plurality of QSs of the plurality of TIDs associated with the plurality of ACs into the at least one MPDU according to the comparison result comprises:
when the number of the at least one MPDU is smaller than the second threshold, filling a QS of a TID with a highest priority among the at least one TID and a paired QS of a paired TID corresponding to the TID into the at least one second control field according to a priority order of the plurality of ACs;
filling at least one QS of at least one TID other than the TID and the paired TID in the plurality of TIDs into the at least one first control field in order according to the priority order; and
filling a remaining QS of a remaining TID with a highest priority among at least one remaining TID in the plurality of TIDs into the at least one third control field, or filling at least one remaining QS of the at least one remaining TID into the at least one third control field;
wherein when any of the plurality of QSs has a value of 0, the processing circuit ignores the QS with the value of 0.

6. The communication device of claim 2, wherein each of the at least one first control field comprises a quality of service (QOS) data frame or a QoS null frame.

7. The communication device of claim 2, wherein each of the at least one second control field comprises an access control information (ACI) high subfield and a QS high subfield.

8. The communication device of claim 2, wherein each of the at least one third control field comprises an ACI bitmap subfield, a delta TID subfield and a QS all subfield.

9. The communication device of claim 1, wherein the length parameter is an A-MPDU maximum length.

10. The communication device of claim 1, further comprising:
a receiving circuit, coupled to the determination circuit, for receiving the length parameter from the network device, wherein the length parameter is a buffer status report poll (BSRP) uplink (UL) length.

11. The communication device of claim 1, wherein the first threshold is a maximum number of the plurality of TIDs.

12. The communication device of claim 1, wherein the second threshold is a number of the plurality of ACs.

13. The communication device of claim 1, wherein the plurality of TIDS corresponds to the plurality of QSs, respectively.

14. A method for reporting queue size (QS) of access category (AC), comprising:
determining a number of at least one media access control (MAC) protocol data unit (MPDU) according to a length parameter;
comparing the number of the at least one MPDU, a first threshold and a second threshold, to generate a comparison result, wherein the first threshold is greater than the second threshold;
generating the at least one MPDU, and filling a plurality of QSs of a plurality of traffic identifiers (TIDs) associated with a plurality of ACs into the at least one MPDU according to the comparison result;
aggregating the at least one MPDU, to generate an aggregated MPDU (A-MPDU); and
transmitting the A-MPDU to a network device.

15. The method of claim 14, wherein the at least one MPDU comprises at least one first control field, at least one second control field and at least one third control field.

16. The method of claim 14, wherein the step of filling the plurality of QSs of the plurality of TIDs associated with the plurality of ACs into the at least one MPDU according to the comparison result:
when the number of the at least one MPDU is not smaller than the first threshold, filling the plurality of QSs into the at least one first control field in order according to the plurality of TIDS; and
when at least one remaining first control field among the at least one first control field is not filled, changing at least one remaining MPDU comprising the at least one remaining first control field to at least one end-of-frame (EOF) padding subframe.

17. The method of claim 14, wherein the step of filling the plurality of QSs of the plurality of TIDs associated with the plurality of ACs into the at least one MPDU according to the comparison result:
when the number of the at least one MPDU is smaller than the first threshold and is not smaller than the second threshold, filling at least one QS of at least one TID among the plurality of TIDs into the at least one first control field in order according to a priority order of the plurality of ACs;
when at least one remaining first control field among the at least one first control field is not filled, filling at least one paired QS of at least one paired TID with high priority among the plurality of TIDs into the at least one remaining first control field in order according to the priority order and filling a remaining paired QS of a remaining paired TID with a highest priority among at least one remaining paired TID other than the at least one paired TID in the plurality of TIDS into the at least one second control field,;
when the at least one first control field is filled, filling a paired QS of a paired TID with a highest priority among the at least one paired TID into the at least one second control field; and
filling a QS of a TID with a second highest priority among the at least one remaining paired TID or the at least one paired TID into the at least one third control field, or filling at least one remaining QS of at least one remaining TID among the at least one remaining paired TID or the at least one paired TID into the at least one third control field;
wherein when any of the plurality of QSs has a value of 0, the processing circuit ignores the QS with the value of 0.

18. The method of claim 14, wherein the step of filling the plurality of QSs of the plurality of TIDs associated with the plurality of ACs into the at least one MPDU according to the comparison result:
when the number of the at least one MPDU is smaller than the second threshold, filling a QS of a TID with a highest priority among the at least one TID and a paired QS of a paired TID corresponding to the TID into the at least one second control field according to a priority order of the plurality of ACs;
filling at least one QS of at least one TID other than the TID and the paired TID in the plurality of TIDs into the at least one first control field in order according to the priority order of the plurality of ACs; and
filling a remaining QS of a remaining TID with a highest priority among at least one remaining TID in the plurality of TIDs into the at least one third control field, or filling at least one remaining QS of the at least one remaining TID into the at least one third control field;
wherein when any of the plurality of QSs has a value of 0, the processing circuit ignores the QS with the value of 0.

19. The method of claim 14, wherein the length parameter is a MPDU maximum length.

20. The method of claim 14, further comprising:
receiving the length parameter from the network device, wherein the length parameter is a buffer status report poll (BSRP) uplink (UL) length.
